(19) United States
(12) Patent Application Publication
(10) Pub. No.: US 2022/0101383 A1
(43) Pub. Date: Mar. 31, 2022

(54) SYSTEMS AND METHODS FOR A SOCIAL SYNDICATE PLATFORM FOR BUYERS AND SELLERS

(71) Applicant: Wells Fargo Bank, N.A., San Francisco, CA (US)

(72) Inventors: Miriam S. Bloom, San Francisco, CA (US); Nathan C. Bricklin, Walnut Creek, CA (US); Daniel David, Charlotte, NC (US); Ha M. Duong, San Francisco, CA (US); Praveen Gondra, Fremont, CA (US); Ashish B. Kurani, Hillsborough, CA (US); Julie V. Milbrand, Corte Madera, CA (US); John L. Miller, JR., Corte Madera, CA (US); Darius Miranda, San Francisco, CA (US); Jenny Y. Tao, Belmont, CA (US)

(21) Appl. No.: 15/264,089

(22) Filed: Sep. 13, 2016

(51) Int. Cl. G06Q 30/02; G06Q 40/00; G06Q 50/00

(52) U.S. Cl. CPC G06Q 30/0269; G06Q 50/01; G06Q 40/12

(57) ABSTRACT

Systems and methods related to a social syndicate platform for buyers and sellers on a social network includes aggregating requests for goods or services by individual members of a social network. Individual members may send buyer-sourced requests for deals to business members of the social network with parameters restricting which businesses may be considered in the request. Business members may send discounted offers for goods and services including restrictions on which individuals may receive the offer. A computing system may facilitate deals between businesses and individuals based on financial health considerations and make offer recommendations to business and deal recommendations to individuals.

### BACKGROUND

The proliferation of the internet has fundamentally changed various aspects of individuals' lives, such as communication, work, education, finance, social and personal relationships, etc. For example, the internet has remarkably increased the amount of information available and decreased the transaction cost of obtaining such information. In addition, the internet has enabled a wider range of individuals to meet and interact and form social groups online with extensions to offline groups and activities. Such social networks can be formed for a variety of reasons and can be based on a shared interest, characteristic, or identification of the members of the social network. Businesses have also been joining social networks to promote the business and to communicate with customers and potential customers.

### SUMMARY

One embodiment relates to a method performed on a computing system capable of receiving financial account information from a financial institution computer system and includes receiving financial information from a financial account for a user of a social syndicate deal platform. The method further comprises analyzing financial information from the financial account to determine a financial health of the user and providing a social syndicate deal platform. The social syndicate deal platform further performs the method by providing a plurality of syndicated deal offers, each syndicated deal offer requiring a plurality of users to accept the offer in order for the deal to be executed, analyzing the plurality of syndicated deal offers to identify financially healthy deal offers, the financially healthy deal offers including those of the plurality of syndicated deal offers for which the user joining the deal would not result in the financial health of the user falling below a predetermined value, and sending the financially healthy deal offers to the user.

Another embodiment relates to a method of facilitating a buyer-sourced deal for a good or service executing on a computing system that includes receiving a request from a first individual member of a social network over a network. The request comprises information identifying a requested deal for a good or service and an indication to add other individual members to the requested deal. The computing system sends the information identifying the requested deal for the good or service to a second individual member of the social network and receives a confirmation from the second individual member of a social network via the network, the confirmation comprising acceptance of the requested deal for the good or service. The computing system checks information identifying the requested deal for the good or service and information regarding financial health of at least one of the first individual member and the second individual member against a value of a parameter set by a business member of the social network and then sends the information identifying the requested deal for the good or service to the business member if the parameters set by the business member regarding deals of this nature are met or exceed a threshold.

Another embodiment relates to a method of facilitating offers from a business executing on a computing system that includes determining a recommendation for an offer for a business member of a social network and sending the recommendation to the business member. The computing system then receives an acceptance of the recommendation from the business member, the acceptance comprising an offer and one or more parameters for determining a set of individual members to be sent the offer. One of the parameters is associated with a respective financial health of individual members. The computing system identifies a set or subset of individual members of the social network based on the one or more parameters and sends them the offer. The computing system receives an acceptance of the offer from the one or more of the individual members of the set.

Another embodiment relates to a system for receiving requests from individual members of a social network, the system comprising a network interface, a member database configured to store individual and business member information, and at least one processor. The at least one processor is configured to receive a request from a first individual member of a social network over a network. The request comprises information identifying a requested deal for a good or service and an indication to add other individual members to the requested deal. The processor is further configured to send the information identifying the requested deal for the good or service to a second individual member of the social network, receive a confirmation from the second individual member of a social network via the network, the second request comprising acceptance of the requested deal for the good or service, and check information identifying the requested deal for the good or service and information regarding financial health of at least one of the first individual member and the second individual member against a value of a parameter set by a business member of the social network. The processor is further configured to send the information identifying the requested deal for the good or service to the business member consequent to information identifying the requested deal for the good or service being within the value of the parameter set by the business member, receive an approval from the business member of the requested deal for the good or service, the approval comprising a price, and send confirmation of the approval to at least one of the first individual member and the second individual member.

Another embodiment relates to a non-transitory computer-readable media having computer-executable instructions embodied therein that, when executed by one or more processors, of a computer system cause the computer system to perform a process including receiving a request from a first individual member of a social network over a network, the request comprising information identifying a requested deal for a good or service, and an indication to add other individual members to the requested deal, sending the information identifying the requested deal for the good or service to a second individual member of the social network, receiving a confirmation from the second individual member of a social network via the network, the second request comprising acceptance of the requested deal for the good or service, checking information identifying the requested deal for the good or service and information regarding financial health of at least one of the first individual member and the second individual member against a value of a parameter set by a business member of the social network, sending the information identifying the requested deal for the good or service to the business member consequent to information identifying the requested deal for the good or service being within the value of the parameter set by the business member, receiving an approval from the business member of the requested deal for the good or service, the approval comprising a price, and sending confirmation of the approval to at least one of the first individual member and the second individual member.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a system for facilitating a social syndicate platform for buyers and sellers shown according to an example embodiment.

FIG. 2 is a flow diagram of a method of receiving requests from individual members of a social network for buyer-sourced deals on goods or services shown according to an example embodiment.

FIG. 3 is a flow diagram of a method of recommending and receiving offers from business members of a social network for discounts on goods or services shown according to an example embodiment.

FIG. 4 is an interface on a display of an individual computing device, including graphics displaying deal requests as well as buyer-sourced deals, shown according to an example embodiment.

### DETAILED DESCRIPTION

Referring generally to the figures, systems and methods for facilitating a social syndicate platform for buyers and sellers are shown. Such systems and methods may use social networks with both individual and business members communicating over a network. In some arrangements, the computing system running the social network also run the social syndicate platform. In some arrangements, the computing systems associated with individuals, businesses, and the social network communicate over the network to a computing system associated with a financial institution to provide additional information for facilitating offers of buying and selling goods or services between the individuals and the businesses. In some arrangements, the social network runs on the financial institution computing system or the financial entity otherwise has a measure of control on running the social network. In some arrangements, both the social network and the social syndicate platform runs on the financial institution computing system. In some arrangements, the social syndicate platform, on its own, or running as part of social network computing system and/or a financial institution computing system facilitates financially healthy deals between individual and business members of the social network. The deals can be buyer-initiated or seller-initiated. The financial institution computing system analyzes the individual members' financial health to recommend deal offers that are financially healthy for the individuals. The social syndicate platform can also analyze social media accounts on the social network computing system of individual members to determine non-financial interests to facilitate the recommendation of deal offers. The financial institution computing system also analyzes the financial position of business members to recommend prospective deal offers to the business members of the social network.

In addition, embodiments described herein solve the technical and internet-centric problem of determining which of a plurality of crowd-sourced deals to be offered to individual members of a social network, the acceptance of which will not hurt the financial health of the individual member, for display on an individual computing device of the individual member. This is addressed by leveraging an individual member's financial data to analyze the individual member's current financial health as well as a predicted financial health after accepting a prospective buyer-sourced or crowd-funded deal. Only those particular buyer-sourced deals that are relevant to a user's interests and financially sound for the particular individual member may be displayed to the individual on an individual computing device. Similarly, embodiments described herein solve the technical and internet-centric problem of determining what deal offers to recommend to business members of a social network and display on a respective business computing device of the business member, that the business members can in turn offer to individual members that will benefit the financial health of the respective business member. This is addressed by leveraging a businesses' financial data to analyze the businesses' current financial health as well as a predicted financial health after executing an offer to individual members of the social network. Only those particular recommended offers that benefit or at least not hurt the financial health of a respective business are displayed to the business on an associated business computing device. This provides a technical solution to the internet-centric challenge of providing an optimal, individualized internet-based social syndicate platform for facilitating buyer-sourced and crowd-funded deals for goods or services.

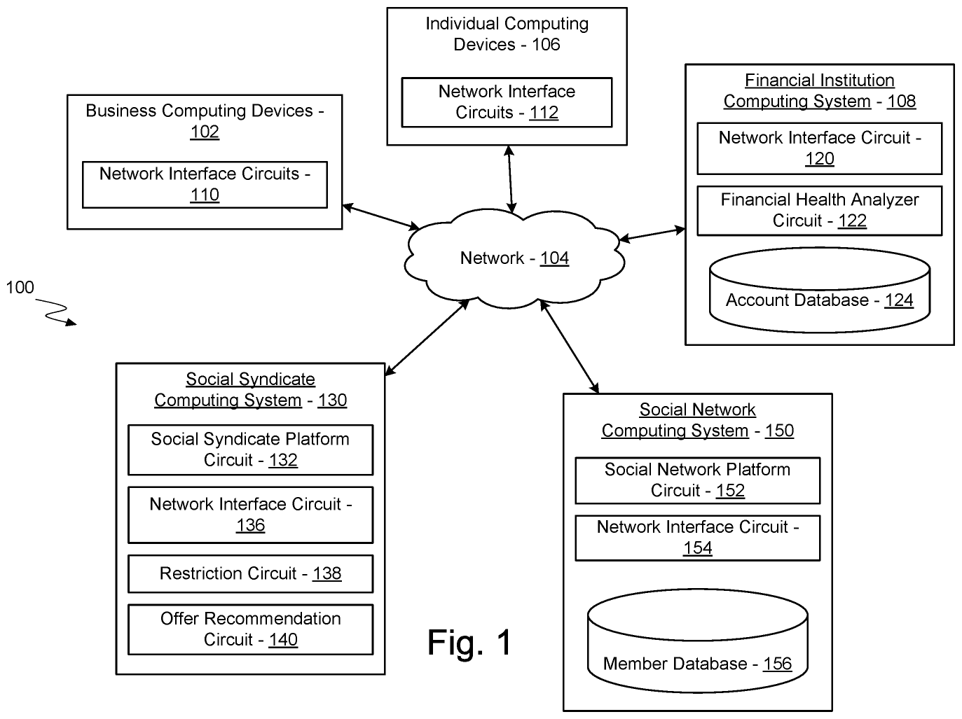

Referring now to FIG. 1, an embodiment of an environment 100 is depicted. In brief overview, the environment 100 includes one or more business computing devices 102 used by businesses and comprises one or more individual computing devices 106 used by individuals connected to a network 104. Also connected to the network 104 are a social syndicate computing system 130, a social network computing system 150, and a financial institution computing system 108. In some arrangements, the individuals and the businesses (e.g., owners, employees, contract employees, administrators, etc.), communicate over the network 104 to the social syndicate computing system 130, the social network computing system 150 and to the financial institution computing system 108 using business computing devices 102 and individual computing devices 108 such as smartphones, laptop computers, desktop computers, tablet computers, and the like. In some arrangements, the social syndicate computing system 130 communicates to the individual computing devices 106, business computing devices 102, the social network computing system 150, and the financial institution computing system 108 over the network 104. In some arrangements, the financial institution computing system 108 communicates to the individual computing devices 106, the business computing devices 102, the social syndicate computing system 130, and the social network computing system 150 over the network 104. In some arrangements, the social syndicate computing system 130 is incorporated into the financial institution computing system 108 or vice versa. In some other arrangements, the social syndicate computing system 130 is incorporated in the social network computing system 150 or vice versa. In some other arrangements, both the social network computing system 150 and the social syndicate computing system 130 is incorporated into the financial institution computing system 108. In arrangements, where one or more of the social syndicate computing system 130, financial institution computing system 108, and the social network computing system 150 are separate computing systems from the other computing systems communicating over the network 104, communication and sharing of information may be aided by application programming interfaces (APIs). The APIs are installed on one or more of the computing systems to facilitate sharing content and data. For example, an API is installed on the social network computing system 150 to share some or all member database 156 information with the social syndicate computing system 130. In reference to components described herein, references to the components in singular or in plural form are not intended as disclaimers of alternative arrangements unless otherwise indicated. The components are configured to interact, in some arrangements, as described in further detail below.

In the environment 100, data communication between the business computing devices 102, the individual computing devices 106, the financial institution computing system 108, the social syndicate computing system 130, and the social network computing system 150 in various combinations is facilitated by the network 104. In some arrangements, the network 104 includes the internet. In other arrangements or combinations, the network 104 includes a local area network or a wide area network. The network 104 may be facilitated by short and/or long range communication technologies including Bluetooth transceivers, Bluetooth beacons, RFID transceivers, NFC transceivers, Wi-Fi transceivers, cellular transceivers, wired network connections, etc.

Still referring to FIG. 1, the individuals using individual computing devices 106 may be in communication with and/or have accounts with the financial institution computing system 108. The individuals may have accounts on the social syndicate computing system 130 and/or be members of the associated social syndicate. In some arrangements, each member of the social syndicate is a member of the social network associated with the social network computing system 150. In some arrangements, individuals include single persons as well as households and families and also include, companies, corporations, or other entities using the system(s) herein to purchase goods and/or services. Individuals may communicate over a respective network interface circuit 112 over the network 104 to a financial institution computing system 108, a social syndicate computing system 130, and/or a social network computing system 150 via individual computing devices 106, such as smartphones, laptop computers, desktop computers, tablet computers, and the like. Data passing through the respective network interface circuits 112 may be encrypted such that the network interface circuit 112 is a secure communication module.

The businesses using business computing devices 102 may be in communication with and/or have accounts with the financial institution computing system 108. The businesses may have accounts on the social syndicate computing system 130 and/or be members of the associated social syndicate. In some arrangements, each member of the social syndicate is a member of the social network associated with the social network computing system 150. Businesses are companies, corporations, partnerships or other entities that use the system(s) herein to offer goods and/or services. In some arrangements, the businesses are local to the neighborhood(s) of individuals (e.g., local plumbers, electricians, handymen, babysitters, painters, gardeners, and the like). In other arrangements, the businesses are not local, but have e-commerce components and provide goods and/or services to the individuals or some subset of the individuals through shipping goods, by providing remote services or through other non-local means of providing goods and services. Businesses may communicate over a respective network interface circuit 110 over the network 104 to a financial institution computing system 108, a social syndicate computing system 130, and/or a social network computing system 150 via business computing devices 102, such as smartphones, laptop computers, desktop computers, tablet computers, and the like. Data passing through the respective network interface circuits 110 may be encrypted such that the network interface circuit 110 is a secure communication module.

The financial institution computing system 108 is associated with a financial institution (e.g., a bank, a credit card issuer, etc.). The financial institution computing system 108 includes a network interface circuit 120, a financial health analyzer circuit 122, and an account database 124. The financial health analyzer circuit 122 controls at least some operations of the financial institution computing system 108 using data stored in databases or other computer storage structures, such as the account database 124. The financial health analyzer circuit 122 is configured to facilitate and/or generate offer recommendations between individuals and businesses connected on a social syndicate platform. Data passing through the network interface circuit 120 may be encrypted such that the network interface circuit 120 is a secure communication module. In some arrangements, the network interface circuit 120, financial health analyzer circuit 122, and the account database 142 reside in part on different servers in relation to other components or to the whole of a particular component.

In some arrangements, the financial health analyzer circuit 122 can be configured to analyze the financial health of individuals and businesses that have accounts with the financial institution. The individuals and businesses may have information on the accounts stored in the account database 124 of the financial institution computing system 108 and information stored in the member database 156 of the social network computing system 150. In some arrangements, the individuals and businesses are also account holders of the financial institution with the respective account information contained in the account database 124. In other arrangements, the individuals or businesses do not have an account with the financial institution computing system 108, but other financial health information is accessible using the network interface circuit 120 of the financial institution computing system 108 (e.g., credit scores from a credit reporting agency). Information used to analyze the financial health of an individual or business may include, liquidity, cash flow, historic cash flow, predicted cash flow based on the historic cash flow, current account balances, recent windfalls, transaction history, predicted upcoming expenses, predicted cash inflow based on historical transactions, and the like. In some arrangements, a financial health score is calculated for the individual or business based on the information available. In some arrangements a financial health profile can be created based on historical transactions, the financial health profile based on predictions of upcoming expenses as well as predictions of future income. In some arrangements, a financial health profile can be created based on values of one or more parameters of individuals or businesses meeting or exceeding certain thresholds. Financial health parameters for individuals may include credit scores, liquid asset positions, liquidity ratio (e.g., liquid assets/monthly expenses), asset to debt ratio (e.g., total assets/total liabilities), current ratio (e.g., liquid assets/short term liabilities), debt service ratio (e.g., short term liabilities/total income), saving ratio (e.g., monthly surplus once recurring liabilities paid), set monthly costs, expenditure volatility, and the like. Financial health parameters for businesses may include cash positions, solvency (e.g., liquid assets/monthly expenses), overhead costs, overhead expense percentage (e.g., overhead expenses/sales), expenditure volatility, seasonal variability, profitability ratios, leverage ratios, revenue growth, gross profit margin, operating margin and the like. In some arrangements, the analysis determines a binary answer, yes or no, of whether the financial health of an individual or the financial health of a business can support a recommendation or request for an offer to provide or be provided a good or service.

Continuing with the financial health analyzer circuit 122, in some arrangements, the financial health analyzer circuit 122 can be configured to analyze the financial health of individuals to not only determine if the individual is a good prospect for purchasing a deal, but also if participating in the deal would negatively affect the individual. For example, the financial health analyzer circuit 122, determines that while an individual is be able to handle a purchase of a $5000 good, the purchase may bring them too close to their maximum on a credit card and negatively affect their credit score, bringing the credit score below an acceptable threshold. Other factors of a financial health profile for individuals may include life changing events (e.g., an indication that a business has just been started due to opening a business account, an indication of a new dependent based on opening a custodial account, an indication of higher revenue for a business due to an increased installment payment for taxes, or other indications that an individual is in a position to spend more or in a position to spend less than usual). In some arrangements, financial health is based on marital status, where a change in marital status, determined by a change of name, opening of a joint account, received information from the social syndicate computing system 130 etc., causes the financial health analysis of two individuals to be joined or analyzed together.

The social syndicate computing system 130 is configured to receive information associated with members of a social network, including business members and individual members from a social network computing system 150 as well as to communicate with the financial institution computing system 108. The social syndicate computing system 130 includes a social syndicate platform circuit 132, a network interface circuit 136, and an offer recommendation circuit 140. The social syndicate platform circuit 132 controls some operations of the social syndicate computing system 130 using data received from the social network computing system 150 and/or the financial institution computing system 108. Data passing through the network interface circuit 136 may be encrypted such that the network interface 130 is a secure communication module. The restriction circuit 138 is configured to restrict individual computing devices 106 and business computing devices 102 from being sent offers to buy and/or sell goods based on parameters of the individuals and businesses. The offer recommendation circuit 140 is configured to analyze available information, factors, and parameters of businesses in order to make recommendations of offers the respective businesses could make to individuals. In some arrangements, the social syndicate platform circuit 132, the network interface circuit 136, the restriction circuit 138, the offer recommendation circuit 140, and the member database 156 reside in part on different servers in relation to other components or to the whole of a particular component. In some arrangements, parts or all of the social syndicate computing system 130 as described herein runs on or is configured to run on the financial institution computing system 108. In some arrangements, parts or all of the social syndicate computing system 130 runs on or is configured to run on the social network computing system 150. In some arrangements, all or a subset of any of the social syndicate computing system 130, the social network computing system 150, and the financial institution computing system 108 run on the same server computing system.

The restriction circuit 138 is configured to determine subsets of the individual members and the business social network members. In some arrangements, restricting total membership of individuals or businesses is based on parameters provided by businesses or individuals via business computing devices 102 and individual computing devices 106. Businesses may supply parameters when they are determining sets or subsets of individuals too offer discounts, specials, special services, unique goods, and the like. Individuals may supply parameters using individual computing devices 106 when requesting a deal, discount, special pricing, specialized services, unique products and the like from businesses or a specific business. In some arrangements, parameters provided by businesses via business computing devices 102 regarding individuals include financial health restrictions, geographical restrictions including neighborhoods, blocks, cardinal directions relative to roads, streets, landmarks and/or the like, demographics, listed interests in social profiles, social profile activity, number of social connections, number of followers, etc. In some arrangements, parameters provided by individuals via individual computing devices 106 regarding businesses include financial health restrictions, online ratings, social network ratings, social network ratings by connections to the individual, geographical restrictions, timing restrictions for delivery of goods and services, etc. In some arrangements, parameters are provided when requesting or offering a good or service. In other arrangements, one or more of the parameters are included in a member profile of the individuals or businesses and taken into account automatically when an offer or request for a good or service is made. Financial health restrictions parameters for individuals may include credit scores, liquid asset positions, liquidity ratio (e.g., liquid assets/monthly expenses), asset to debt ratio (e.g., total assets/total liabilities), current ratio (e.g., liquid assets/short term liabilities), debt service ratio (e.g., short term liabilities/total income), saving ratio (e.g., monthly surplus once recurring liabilities paid), set monthly costs, expenditure volatility, and the like. Financial health restriction parameters for businesses may include cash positions, solvency (e.g., liquid assets/monthly expenses), overhead costs, overhead expense percentage (e.g., overhead expenses/sales), expenditure volatility, seasonal variability, profitability ratios, leverage ratios, revenue growth, gross profit margin, operating margin and the like. In some arrangements, the restriction circuit 138 is part of the configuration of the financial institution computing system 108, and the financial institution computing system determines the subsets of the individual members and the business members based on parameters.

The offer recommendation circuit 140 generates offers to send to respective businesses computing devices 102 of business members of the social network determined from analyzing various financial and other factors and parameters of the business member. In some arrangements, the recommendation circuit 140 also analyzes various financial and other factors and parameters of the individuals that are the potential receivers of any offer generated. In some arrangements various financial and other factors of the respective business includes, liquidity, cash flow, historic cash flow, predicted cash flow based on the historic cash flow, current account balances, recent windfalls, transaction history, predicted upcoming expenses, predicted cash inflow based on historical transactions, inventory, seasonal variations and the like. In some arrangements various financial and other factors and parameters of the individuals includes include, liquidity, cash flow, historic cash flow, predicted cash flow based on the historic cash flow, current account balances, recent windfalls, transaction history, predicted upcoming expenses, predicted cash inflow based on historical transactions, and the like. In some arrangements, the recommendation circuit 140 generates recommendations to individuals for current offers by the businesses. Various financial factors (e.g., overall financial health, account balances, etc.) as well as other factors and parameters of individuals are first analyzed by the recommendation circuit 140 to determine which current business offers would be best recommended. Other factors and parameters may include personal interests of the individual. For example, personal interests may be determined based on user input regarding particular goods or services he or she is interested in or through analysis of social connections, groups joined, posts created, etc. Further factors and parameters may include geographical restrictions on the offers. Social influence of the individual may also be a factor. For example, an offer may only be a better deal if the individual accepting the offer is able to get many others to join and an individual with great social influence will be more likely to get others to join the offer. In some arrangements, the offer recommendation circuit 140 is configured as part of the financial institution computing system 108 and the financial institution computing system 108 generates the offers to send to respective business computing devices 102 of business members.

The social network computing system 150 is configured to create connections for information to be passed and shared between members of the social network, including business members and individual members as well as communicate to a social syndicate computing system 130. The social network computing system 150 includes a social network platform circuit 152, a network interface circuit 154, and a member database 156. The social network platform circuit 152 controls some operations of the social network computing system 150 using data received from the social syndicate computing system and/or business computing devices 102 and individual computing devices 106. Data passing through the network interface circuit 154 may be encrypted such that the network interface 154 is a secure communication module. The social network platform circuit is configured to determine individual member and business member data that can be used and communicated to a social syndicate computing system 130 in order to facilitate social syndicate deals and offers as well as receive offer recommendations and deals to send to the individual computing devices 106 and business computing devices 102 of members. In some arrangements, the social network platform circuit 152, the network interface circuit 154, and the member database 156 reside in part on different servers in relation to other components or to the whole of a particular component. In some arrangements, parts or all of the social network computing system 150 as described herein runs on or is configured to run on the social syndicate computing system 130. In some arrangements, parts or all of the social network computing system 150 runs on or is configured to run on the financial institution computing system 108.

The social network platform circuit 152 is configured to provide information, including profile information, social network connections, posted information, social following information, indicated likes, indicated dislikes, indicated interests, and other available social network data of individual members and the business social network members to the social syndicate computing system 130. In some arrangements, members can opt in or opt out of participating in the social syndicate. In other arrangements, all members are part of the social syndicate. In some arrangements, members that are part of the social syndicate can control what components of their respective available social network information is available to be used in the social syndicate.

The member database 156 is configured to store information related to account information and/or profiles of members of the social network including individual and business members. In some arrangements, membership in a geographic community is a condition of membership of the social network. In other arrangements, businesses can also be a member of the social network even when not geographically local. In some arrangements, a recommendation of an individual member is required to add a business member. In other arrangements, there is no geographic or recommendation requirement.

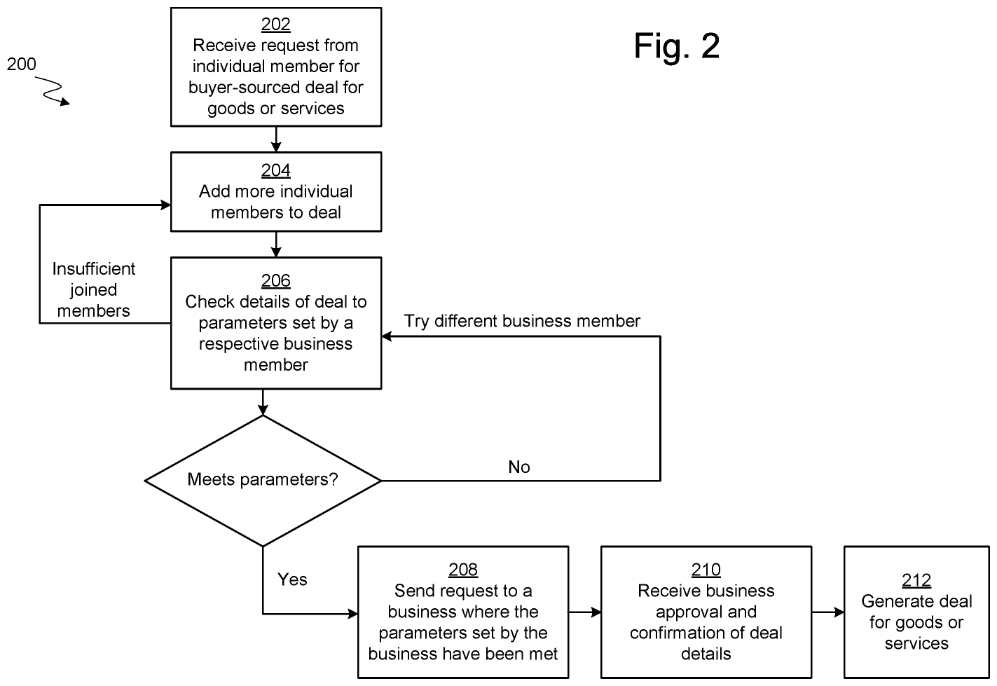

Referring now to FIG. 2, a flow diagram of a method 200 of receiving requests from individual members of a social network for buyer-sourced deals for goods or services is shown according to an example embodiment. The method 200 is performed by a computing system (e.g., a social syndicate platform circuit 132). In some arrangements, method 200 is performed by the social syndicate computing system 130. In other arrangements, method 200 is performed by the financial institution computing system 108 configured to contain some or all of the functionality of the social syndicate computing system 130. Various combinations are also possible with the steps of the method 200 performed across two or more computing systems (e.g. on the financial institution computing system 108 and the social syndicated computing system 130). While performing the method 200, the social syndicate computing system 130, for example, may communicate data over a network interface circuit 136 over the network 104 to business computing devices 102 and/or individual computing devices 106 as well as to a financial institution computing system 108 over a network interface 120. Individuals and businesses as used in one embodiment of the method are members of the social network associated with the social network computing system 150.

The method 200 begins when a computing system receives a request from an individual computing device 106 of a member of a social network for buyer-sourced deals for goods or services at 202. The request can come from any computing device communicating via the network 104 being used by the individual. In some arrangements, a computing device sending the request has to initially provide data showing membership in the social network (e.g., login and password) matching the information in a member database 156 of the social network computing system 150 to be able to send the request. In some arrangements, the request comprises restrictions including price of the good or service, percentage discount for the good or service, geographic requirements for location of the business, availability requirements for the goods or service, shipping speed or carrier, rating thresholds of the business, years the business has been in existence, business size, and the like. In some arrangements, the different restriction requirements can be marked or tagged to be mandatory or desired. In some arrangements, the request includes an additional financial health requirement that the business must satisfy. For example, there is a requirement for the business to exceed a threshold for a business credit profile. Other examples of financial health may include timeliness of payments, liquidity, cash flow, historic cash flow, predicted cash flow based on the historic cash flow, current account balances, recent windfalls, transaction history, predicted upcoming expenses, predicted cash inflow based on historical transactions, and the like. In some arrangements, various factors of financial health are aggregated into a financial health score with a minimum financial health score requirement to be offered the buyer-sourced deal. In some other arrangements, there are restrictions on which of the individuals can initiate buyer-sourced deals for goods or services. Such restrictions on who can initiate may include a length of time being a member of the social network, being a verified member (e.g., verification of name and address, credit check, background check, etc.), amount of influence on other members (e.g., number of followers, number of connections, amount of activity, etc.), rating of products activity, purchase history, social activity outside the specific social network and the like.

Continuing with receiving a request at 202, in some arrangements, the business is a specified business. In other arrangements, the good or service is specified but no particular business is specified. For example, the request is for a group discount on a service to be provided to members in a certain geographical area on a particular day or range of days with no business specified. In other arrangements, the service is a recurring service and the business sets a minimum financial health score of the individual in order to consider the offer. In another example, the request is for a good from a specified business for a product that can be delivered before a specified date. In another example, the service sought differs in complexity for each individual, but a minimum percentage discount for each respective price is specified. In another example, the desired service is restricted to a specific time frame (particular day, week, or range of days). In a further example, an individual proposes a certain number of products from a business to be purchased by a certain date and if enough individuals are added to the buyer-sourced deal, then the purchase price will be a certain price.

Continuing with receiving a request at 202, in some arrangements, the request includes data indicative of a desire to crowdfund the desired product or service. In some arrangements, where crowdfunding is requested, the request includes information about the desired purchase to be shared with others (e.g., through the social network). The information about the desired purchase may include specifications about the product or service, timeframe for purchase, desired purchase price, parameters of individuals to be accepted into the crowdfund pool (e.g., connected social medial individuals only, individuals with similar interests, individuals that have indicated an interest in the product or service on social media, etc.). Individuals may be motivated to crowdfund the purchase to encourage interest in items and activities that they are interested in. The businesses offering the products or services may further provide incentives to help achieve fulfillment by other individuals of crowdfunded requests for goods or services. The incentives may include discounts or free merchandise from the business. In some arrangements further or greater incentives are received if the individual further acts to add more people to the crowdfunded request, shares information about the business, follows the business on social media, etc.

Additional individuals are added to the deal at 204. In some arrangements, other interested individuals are identified by sending information about the proposed deal to the other individuals via their associated individual computing devices 106. In some arrangements, the individuals have indicated a desire to receive such information. The indicated desire to receive proposed group deal information may be part of a user profile of the individual on the social network. In other arrangements, individuals are sent information about the proposed discount if matching a demographic category. In other arrangements, the individuals are sent the information if preferences in a user profile indicate an interest in the type of good or service. In other arrangements, the preferences are determined by an analysis of social media profiles, social media activity (e.g., posted content, completed surveys, following of companies, indications of interest in news stories and blogged articles, social connections to others, etc.). In some arrangements, individuals are not sent offers based on the financial health (e.g., a financial health score) of the individual, if the financial health indicates that it would be in some way detrimental to the individual to participate in the offer at this time. For example, an individual computing device 106 associated with the individual is not sent the offer if a financial analysis indicates that participating in the deal will drop a financial health score of the individual below a designated value. In other arrangements, the potentially participating individuals are further restricted by other parameters set by the individual requesting the buyer-sourced deal. For example, an individual may have a set a preference to not receive offers from businesses based on the financial health of the businesses (e.g., the business falls below a defined financial health score) because the individual prefers to maintain business relationships with businesses that have indications of stability and the ability to maintain long term relationships.

Continuing with adding more individuals to a deal at 204, in some arrangements, the requested deal is for crowdfunding the purchase of the good or service. In some arrangements, where crowdfunding is requested, the individuals receiving the request to join in the crowdfunding has set parameters for the deals they are interested in funding and/or the types of incentives they are interested in receiving when helping to crowdfund a good or service. The parameters may include types or categories of products or services that the individuals may be willing to fund, interests and categories of interests that are related to offered products or services. The parameters may also include specific individuals or categories of individuals for whom they are willing to help crowdfund a purchase. Such categories may include individuals with similar interests, social media contacts, second degree social media contacts (e.g., friends of friends), and the like. Possible incentives may be selectable from a category of options (e.g., X % discount for Y category of businesses) or specified incentives for specified businesses.

Continuing with adding more individuals to a deal at 204, in some arrangements a financial health score is calculated for an individual using any of the financial parameters discussed herein (e.g., credit scores, liquid asset positions, liquidity ratio (e.g., liquid assets/monthly expenses), asset to debt ratio (e.g., total assets/total liabilities), current ratio (e.g., liquid assets/short term liabilities), debt service ratio (e.g., short term liabilities/total income), saving ratio (e.g., monthly surplus once recurring liabilities paid), set monthly costs, expenditure volatility, and the like). In one example, a financial health score for an individual is generated based on the individual's debt to income ratio. The individual has his or her paychecks direct-deposited into a financial institution account of a financial institution associated with the financial institution computing system 108 and the income or a proxy of the individual's income is known by the financial institution. Additionally, the individual has some or all of their credit accounts (e.g., mortgage, lines of credit, credit cards, etc.) at the financial institution and the financial institution knows the debt held by the individual or a proxy of the debt held by the individual and is able to calculate the debt to income ratio. Furthering the example, additional assets known to the financial institution are added to the income of the individual to generate an asset to debt ratio that includes income. In some arrangements, the financial institution can establish and/or use a real time data exchange with other financial institution to pull information associated with the individual to create a more complete financial picture of the individual. Continuing the example, once the financial health score is known, a potential deal is analyzed to assess whether to present the deal to the individual based on the effect on the financial health score of the individual. In a specific example, a potential deal may be for purchase of a new automobile. A calculation based on the individual hypothetically accepting the deal determines that accepting the deal pushes the income to debt ratio of the individual too low and the deal is not presented to the individual. In some arrangements, acceptance pushes the income to debt ratio below a pre-determined threshold. In another result of the calculation, the calculation for the individual hypothetically accepting the deal determines that accepting the deal does not have a significant impact on the financial health score of the individual, and the deal is presented to the individual. In some arrangements, it is determined that the income to debt ratio is still above a pre-determined threshold when determining whether to present the deal to the individual.

Continuing with adding more individuals to a deal at 204, in some arrangements rather than using a single calculated financial score for an individual to determine whether a deal is presented to the individual, the deal is analyzed by applying specific tests using one or more financial parameters associated with the individual. Extending the above example regarding a deal for a new automobile, once the deal for purchasing a new automobile is analyzed to determine the impact on the debt to income ratio of the individual, the deal is then further analyzed based on other financial parameters. For example, the deal is analyzed based on the effect on spare cash flow of the individual using information available to the financial institution based on the financial accounts of the individual. In a specific example, the individual spends $7,500 each month, $5000 of which is for non-discretionary spending (e.g., mortgage, food, etc.). The remaining amount of discretionary spending is determined to be insufficient to support the addition of a new monthly automobile payment without cash flow falling below a threshold. In some arrangements, other factors are taken in to account when analyzing cash flow including failures to meet monthly obligations (e.g., late on mortgage payments, increasing credit card balances each month, etc.). In some arrangements, a distinction is made between deals for necessities and deals for luxuries (e.g., a deal for a new automobile is not presented to an individual, but a deal for diapers is presented as the individual would be purchasing either way). Continuing the example, the deal is further analyzed using another specific test based on a savings profile of the individual. In a specific example, the individual is determined to have no savings or has set savings goals but is not meeting the savings goals and a determination is made the savings is insufficient to support the addition of a new automobile. In some arrangements, further distinctions are made based again on deals for necessities and deals for luxuries (e.g., a deal for a luxury automobile is not presented while the individual is currently making car payments but a deal for a fuel efficient economy car when financial history shows the user made a final payment on a five year car loan five years ago is presented to the individual because they are likely to be in the market for a new automobile as a necessity).

Continuing with adding more individuals to a deal at 204 and the analysis of deals by analyzing financial factors, the use of the specific tests approach allows for the type of deal to be taken into account when determining the deal is financial healthy for the individual. For example, if a financial factor of debt to income ratio is being analyzed, a deal for a pre-owned automobile for $10,000 might be more likely to be presented to the individual than a vacation package for $5,000 as a pre-owned automobile can be resold to recoup some value if needed. Accordingly, when analyzing more than one factor, the analysis of debt to income ratio may be weighted more heavily when the deal is for a good that retains value then if the deal is for a consumable good or service. In another example, if the deal is for items that are necessities that the individual purchases anyway, a financial factor involving cash flow may be weighted less when the deal is for a luxury item, a more discretionary item, or an item that the individual has not purchased in the past. In another example, if the financial factor being analyzed is for a savings profile of the individual, a deal that involves investments (e.g., a deal for gold investment coins) is more likely to be presented while deals for discretionary items are again less likely to be presented. In some arrangements, separate financial scores are generated for one or more of the financial factors being analyzed for the individual. In some arrangements, each analyzed separate financial score is weighted more or less depending on the type and nature of the deal. In some arrangements, the analysis of one of the separate financial scores is a deal breaker, suspending the analysis of the remaining financial factors. In some arrangements, two or more of the separate financial scores are aggregated to create an aggregated financial health score for participation of the individual in the prospective deal offer.

A computing system checks the details of the deal to parameters set by the businesses via business computing devices 102 at 206. In some arrangements, businesses have to opt in to be considered for buyer-sourced deals for goods or services. In some arrangements, all businesses that are members of the social network are considered to be opted in for consideration. In other arrangements, restrictions are put in place by the businesses that allow them to be considered for some buyer-sourced deals and not others. Suitable businesses meet any restrictions that are mandatory. Parameters may include the type of business, the type of goods or services offered by the business, specific lists of goods and services offered by the business, price limits of requests received, percentage thresholds of discounts of requests received, timing considerations of requested delivery or requested providing of services, and the like. In some arrangements, which businesses are checked is restricted by the social syndicate computing system 130. Restrictions used may include business details such as services or goods offered, availability, location, online ratings, financial health of the business, and the like. Such restrictions may be used by the social syndicate computing system 130 to match all available buyer-sourced deals for goods or services to appropriate businesses. In some arrangements, the restrictions are sent to the social network computing system 150 in order to match to appropriate businesses. In some arrangements, a score is assigned to businesses determined by the match between buyer-sourced deals and the business and used to recommend buyer sourced deals to the best matched businesses. In some arrangements, the buyer-sourced deal meets all the parameters set by the respective business via business computing devices 102 except for a minimum number of participants. The deal may still be sent to the business and approved contingent on the minimum number of participants being subsequently reached. In another arrangement, the business adjusts the minimum number of participants or waives the minimum once it has received the buyer-sourced deal request and proceeds with the deal. In another arrangement, the price of the good or service, is tied to the number of individuals that eventually join the buyer-sourced deal with the price dropping or the percentage of the discount rising as more individuals join the deal.

Continuing with checking details of deal to parameters set by a respective business member at 206, in some arrangements, the requested deal is for crowdfunding the purchase of the good or service. In some arrangements, where crowdfunding is requested, businesses have set parameters defining categories of individuals that are able to request or participate in funding crowdfunded products or services. These categories may include potential new customers (i.e., not a current customer), current customers, current loyal or prolific customers, individuals with social clout and influence (e.g., individuals with many followers on social media, individuals with many positive product ratings, and individuals following the business and/or similar businesses).

A computing system sends or submits a request for the good or service requested by the requesting individual via an individual computing device 106 to a business that has parameters set that match the details of the deal at 208. In some arrangements, the request is sent by a social syndicate computing system 130. In other arrangements, the request is sent by the financial institution computing system 108 configured to contain some or all of the functionality of the social syndicate computing system 130. In some arrangements, meeting of all parameters for the requesting individuals as well as the businesses creates a mutually agreed obligation for the deal or transaction between the requesting individuals and the business. In other arrangements, the selected business must still confirm or approve of the transaction in order for there to be mutual obligations between the individuals and the selected business for the goods or services. In some arrangements, a list that includes all businesses that have parameters that meet the details of the deal is first sent to one or more individual computing devices 106 of individuals that are buyer-sourcing the deal and the one or more individuals can select one or more of the businesses on the list to be sent the buyer-sourced deal. In other arrangements, only a subset of the list is sent to the requesting individual, containing a selected number of only the top ranked businesses that have parameters that meet the details of the deal.

A computing system receives an approval from a business computing device 102 associated with a business that has been sent the buyer-sourced deal at 210. In some arrangements, the computing system is the social syndicate computing system 130. In other arrangements, the approval is received by the financial institution computing system 108 configured to contain some or all of the functionality of the social syndicate computing system 130. In some arrangements, the approval includes confirmation of the deal details. In some arrangements, this creates a mutually agreed obligation for the transaction between the individuals that have joined the buyer-sourced deal and the business. Various combinations are also possible where one or more of the requesting individuals and the businesses still has to finally confirm or approve of the transaction in order for there to be mutual obligations between any plurality of individuals and the business for the desired service or good. In some arrangements, the approval contains a contract for the individuals to sign to create mutual obligations for the deal. In some arrangements, the contract is automatically generated by the computing system.

A computing system generates the deal for goods or services at 212. In some arrangements, the computing system is the social syndicate computing system 130. In other arrangements, the deal is generated by the financial institution computing system 108 configured to contain some or all of the functionality of the social syndicate computing system 130. In some arrangements, generating the deal includes sending details of the deal to the individual computing devices 106 associated with individuals that requested the buyer-sourced deal. In some arrangements, a contract for the individuals to sign is sent with the details of the deal. In some arrangements, the social network computing system 150 facilitates payment to the business using a trusted account set up on a financial institution computing system 108. This may encourage more confidence in any transaction between the individuals and businesses. In some arrangements, facilitation using a trusted payment procedure involves a temporary account set up in the financial institution computing system 108 to hold funds related to the respective transaction in escrow with the financial institution acting as an escrow agent. In other arrangement, the financial institution computing system 108 maintains the trusted account holding the escrow funds, but the social syndicate computing system 130 acts as the escrow agent.

In some arrangements, additional incentives can be offered by the business for the individual that first initiated the buyer-sourced deal request. The additional incentives can take the form of an additional discount on the good or service, receiving the good or service for free, receiving additional goods or services, receiving additional goods or services different than the original deal request, getting entered in a prize drawing, receiving promotional materials, and the like. In other arrangements, the additional incentives can be offered to any of the individuals that are particularly effective in getting other individuals to join the buyer-sourced deal.

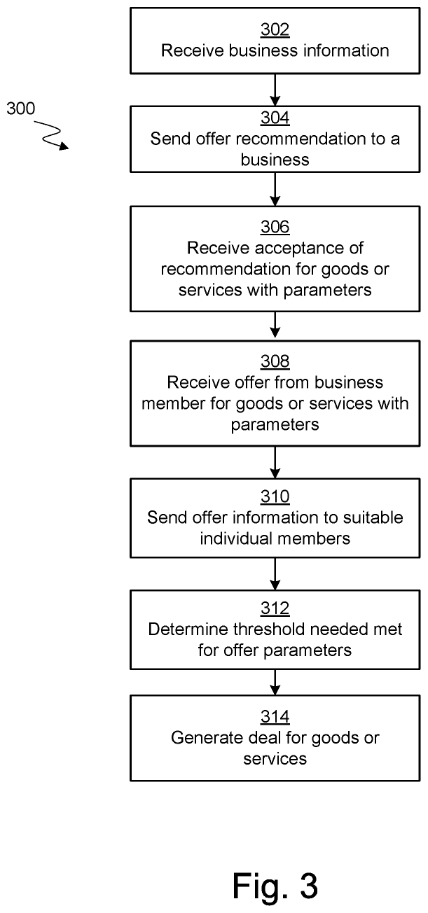

Referring now to FIG. 3, a flow diagram of a method 300 of recommending and receiving offers from businesses via business computing devices 102 for discounts on goods or services is shown according to an example embodiment. The method 300 is performed by a computing system (e.g., a social syndicate platform circuit 132). In some arrangements, method 300 is performed by the social syndicate computing system 130. In other arrangements, method 300 is performed by the financial institution computing system 108 configured to contain some or all of the functionality of the social syndicate computing system 130. While performing the method 300, the social syndicate computing system 130 may communicate data over a network interface circuit 136 over the network 104 to business computing devices 102 and/or individual computing devices 106 as well as to a financial institution computing system 108 over a network interface 120. Individuals and businesses as used in one embodiment of the method are members of the social network associated with the social network computing system 150. The method 300 begins when the social syndicate computing system 130, for example, receives business information from a business computing device 102 at 302. In some arrangements, the business is a member of the social network running on the social syndicate computing system 130. In other arrangements, the business is a prospective member of the social network. Business information received may comprise various details on the business including stated financial position, stated goals (e.g., sale quotas, required revenues, etc.), inventory information, financial account details, seasonal business variations, and the like.

A computing system sends offer recommendations to a business via a business computing device 102 at 304. In some arrangements, the computing system is the social syndicate computing system 130. In other arrangements, the offer recommendations are sent by the financial institution computing system 108 configured to contain some or all of the functionality of the social syndicate computing system 130. In some arrangements the business is a business member of the social network. In some arrangements the offer recommendation is for a discount on goods or services or specialty services particular to the business. The offer can be retrieved by any computing device (e.g., a business computing device 102) communicating via the network 104 associated with the business. In some arrangements, the business computing device 102 has to provide login and password information matching the information in a member database 156 of the social network computing system 150 to be able retrieve the offer recommendations. In some arrangements, offer suggestions are based on the financial position, stated goals, and/or inventory data of businesses. In one example, a business has a stated goal of selling 300 units of inventory at a price that is no lower than a discounted $35. The social syndicate computing system 130 analyzes the financial health and interests of individual members of the social network and recommends that the business offer a deal, the analysis indicates a discounted price of $40 is feasible, and to cap the total number of individual members able to participate at five-hundred based on the stated goal as well as available inventory information. In another example, a business has a stated goal of a total revenue of $500,000 for the quarter, the social syndicate computing system 130 analyzes the financial health and interests of individuals and determines that certain discounts on various inventory items being held by the business will accomplish the total revenue goal for the quarter. In a related example, the social syndicate computing system 130 analyzes that discounting one or more services by a business will generate enough activity to meet the total revenue goal and recommends discounts to offer.

A computing system receives an acceptance of the offer recommendation from a business via a business computing device 102 related to goods or services along with parameters at 306. In some arrangements, the computing system is the social syndicate computing system 130. In other arrangements, the acceptance is received by the financial institution computing system 108 configured to contain some or all of the functionality of the social syndicate computing system 130. In some arrangements, the business is a member of the social network associated with the social network computing system 150. The offer is accepted with no material alterations to the details of the offer recommendation. In other arrangements, the offer is accompanied with alterations and/or certain parameters required by the business. In some arrangements, one or more of the parameters is present in a profile of the business stored in the social syndicate computing system 130 associated with the business instead of being received with the offer. Parameters may include financial health of individuals to receive the offer, geographical restrictions including neighborhoods, blocks, cardinal directions relative to roads, streets, landmarks and/or the like, minimum and maximum number of goods or services available, timing restrictions, etc. Any additional restrictions and parameters not added automatically are sent by a business computing device 102 associated with the business.

A computing system receives an offer from a business computing device 102 associated with a business, the offer related to goods or services and comprising parameters at 308. In some arrangements, the computing system is the social syndicate computing system 130. In other arrangements, the offer is received by the financial institution computing system 108 configured to contain some or all of the functionality of the social syndicate computing system 130. In some arrangements, the business is a member of the social network associated with the social network computing system 150. In some arrangements, the offer is consequent to an acceptance of an offer recommendation at 306. The offer may be accompanied by certain parameters required by the business. In some arrangements, one or more of the parameters is present in a profile of the business stored in the social syndicate computing system 130 associated with the business instead of being received with the offer. Parameters may include financial health restrictions and geographical restrictions including neighborhoods, blocks, cardinal directions relative to roads, streets, landmarks and/or the like. The parameters may also be timing restrictions. Timing restrictions may restrict the offer to a certain day, week, span of days, require acceptance prior to a certain date, require performance prior to a certain date, etc. In some arrangements, the different parameters encompassing restriction requirements can be marked or tagged to be mandatory or desired.

A computing system sends the discount offer information for goods to suitable, individual computing devices 106 associated with individuals at 310. In some arrangements, the computing system is the social syndicate computing system 130. In other arrangements the discount offer information is sent by the financial institution computing system 108 configured to contain some or all of the functionality of the social syndicate computing system 130. In some arrangements, all individuals that are members of the social network are considered to be suitable to receive offer information. In other arrangements, further requirements are required for the individual to be suitable such as geographical restrictions applying to only a subset of individuals, profile settings of the individuals that opt out of receiving discount offer information, financial health of individuals, buying habits of individuals, elements of the social media profiles of the individuals indicating interests, etc., depending on the restrictions and parameters received in the request or present in a profile associated with the business.

A computing system determines that the threshold for any parameters of the offer have been met at 312. In some arrangements, the computing system is the social syndicate computing system 130. In other arrangements, the determination is done by the financial institution computing system 108 configured to contain some or all of the functionality of the social syndicate computing system 130. In some arrangements, the business receiving the requests for the discounted goods completes a mutually agreed obligation for the transaction between the requesting individual and the business. In other arrangements, the selected business must still confirm or approve of the transaction in order for there to be mutual obligations between the individual and the selected business for the goods or services. In some arrangements, the business receiving the requests for the discount or specialized services completes a mutually agreed obligation for the transaction between the requesting individual and the business. In other arrangements, the selected business must still confirm or approve of the transaction in order for there to be mutual obligations between the individual and the selected business for the goods or services.

A computing system generates the deal for goods or services at 314. In some arrangements, the computing system is the social syndicate computing system 130. In other arrangements, the deal is generated by the financial institution computing system 108 configured to contain some or all of the functionality of the social syndicate computing system 130. In some arrangements, generating the deal includes sending details of the deal to the individual computing devices 106 associated with individuals that have accepted the sent offer from the business. In some arrangements, a contract for the individuals to sign is sent with the details of the deal. In some arrangements, the social network computing system 150 facilitates payment to the business using a trusted account set up on a financial institution computing system 108. This may encourage more confidence in any transaction between the individuals and businesses. In some arrangements, facilitation using a trusted payment procedure involves a temporary account set up in the financial institution computing system 108 to hold funds related to the respective transaction in escrow with the financial institution acting as an escrow agent. In other arrangement, the financial institution computing system 108 maintains the trusted account holding the escrow funds, but the social syndicate computing system 130 acts as the escrow agent.

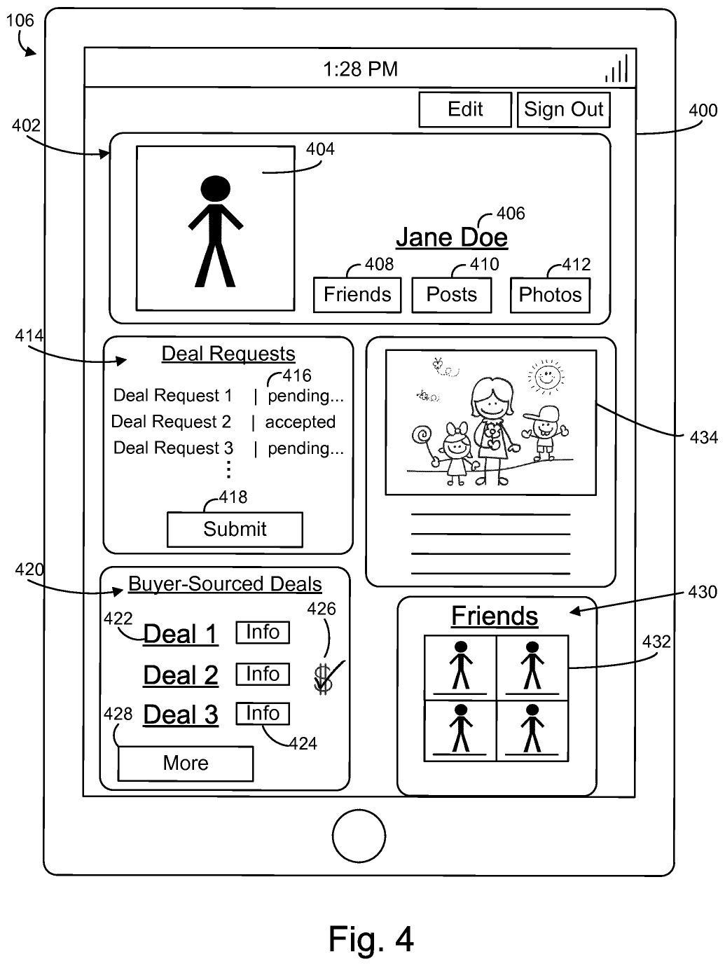

Referring now to FIG. 4, an interface 400 on a display of an individual computing device 106, including graphics displaying deal requests as well as graphics displaying buyer sourced deals, is shown according to an example embodiment. In one embodiment, the interface 400 is provided by the social network computing system 150. Other embodiments may have one or more components of the interface 400 provided by the social syndicate computing system 130 (e.g., from the social syndicate platform circuit 132 and/or the offer recommendation circuit 140) and/or the financial institution computing system 108 (e.g., by the financial health analyzer circuit 122). The interface 400 may include information relating to a social networking profile held by an individual user of the social network computing system 150. The social networking profile may be provided by the social network computing system 150. A profile area 402 of the interface 400 includes information relating to the individual user, including a profile picture 404 and a user name 406. The profile picture 404 and user name 406 may be selected by the user. A user can access a list of the user's friends (e.g., connections, followers, family, etc.) posts (e.g., messages, tweets, etc.), and photos by interacting with buttons 408, 410, and 412, respectively. A deal requests area 414 of the interface 400 includes one or more graphics depicting buyer-sourced deal requests initiated by the individual user. In this embodiment, the deal requests area 414 includes a status column 416 indicating whether the deal has been accepted or still pending. A status indication of pending may indicate that a deal request has been accepted by a business member of the social network and/or that a required number of individual members have joined in the deal. The area also includes a submit button 418 to submit new deal requests. New deal requests may comprise one or more restrictions including price of the good or service requested, percentage discount for the good or service requested, geographic requirements for location of the business, availability requirements for the goods or service requested, shipping speed or carrier, rating thresholds of the business, years the business has been in existence, business size, and the like. In some arrangements, the different restriction requirements can be marked or tagged to be mandatory or desired. In some arrangements, the request includes an additional financial health requirement that the business must satisfy.

Continuing with FIG. 4, buyer-sourced deals area 420 of the interface 400 includes one or more graphics depicting available buyer-sourced deals initiated by other individual users. In some embodiments, the buyer-sourced deals area 420 or a similar area of the interface 400 may instead or also display business member sourced deals. In this embodiment, the buyer-sourced deals 420 area includes a list of clickable deals 422 that are available. Clicking on one of the deals allows the individual user to join in the deal. Info buttons 424, when clicked, bring up additional information about the particular buyer-sourced deal. In some embodiments, the additional information includes number of individual participants, an identity of the original requester of the buyer-sourced deal, a required number of participants for the deal, information on an associated business member linked to the deal including information on the financial health of any associated business member, and the like. The buyer-sourced deals area 420 also may include a financially healthy graphic 426 indicating whether a particular buyer-sourced deal is financial healthy for the individual member to participate in. The indication is accomplished in other embodiments using a numerical score, a color scheme, and/or another indicator. Different graphics may be used for different levels or scores of how financial healthy a respective buyer-sourced deal is for an individual member. In some embodiments, the use of the financially healthy graphic 426 is based on overall financial health information of the individual member. The overall financial health information can be further analyzed using the details of the respective deal (e.g., total cost of deal, monthly cost of deal, debt load of individual member, financial liquidity of individual member, credit card limits of individual member, etc.). The buyer-sourced deals area 420 also may include a more button 428 to view additional buyer-sourced deals.

A friends area 430 of the interface 400 includes one or more friend icons 432, each indicating a friend, follower, or other type of connection of the individual user within the social network. The friend icons 432 that are shown in the friends area 430 may be selected from the individual user's friends based on any number of criteria, including the number or frequency of interactions with the individual user (or with a viewer of the interface 400). In some embodiments, the displayed friend icons 432 are selected based on shared buyer-sourced deals participated in with the individual member user. The interface 400 also includes user posts 434, which may include photos, status updates, messages from friends, and the like. The user posts 434 may also include updates on any buyer-sourced deals requested by friends of the individual member.

A version of interface 400 for business members (not shown) may contain similar features. In some embodiments business members would be able to submit offers for goods or services with parameters using the interface. Such offers from business members with parameters may include parameters such as financial health restrictions of individual members wishing to join and geographical restrictions including neighborhoods, blocks, cardinal directions relative to roads, streets, landmarks, and/or the like. The parameters may also comprise timing restrictions. Timing restrictions may restrict the offer to a certain day, week, span of days, require acceptance prior to a certain date, require performance prior to a certain date, etc. In some arrangements, the different parameters encompassing restriction requirements can be marked or tagged to be mandatory or desired. The version of interface 400 for business members may also include received offer recommendations for the business member to consider. In some arrangements, offer suggestions are based on the financial position, financial health, stated goals, and/or inventory data of the business member.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method performed by one or more computing systems, the method comprising:
receiving, by a social syndicate computing system via a network from a financial institution computing system, financial information from financial accounts managed for a plurality of users including a first user;
receiving, by the social syndicate computing system via the network from a business computing device associated with a business, one or more parameters relating to a financial health restriction of users restricted from accepting offers of the business;
analyzing, by the social syndicate computing system, the financial information from the financial accounts to determine a respective value of a financial factor of the plurality of users;
providing, by a social syndicate platform circuit of the social syndicate computing system, a social syndicate deal platform, wherein providing the social syndicate deal platform includes:
receiving, by the social syndicate computing system via the network from a device of a second user, a request for syndicated deal offer requiring at least a subset of the plurality of users including the second user to accept the offer in order for the deal to be executed,
analyzing, by the social syndicate computing system, for at least some of the plurality of users including the first user, the respective value of the financial factor to identify the subset of users, wherein analyzing the respective value comprises:
calculating, by the social syndicate computing system, the value of the financial factor of the at least some users including the first user, based on one or more of a value of a credit score, liquid asset position, liquidity, asset to debt ratio, current ratio, debt service ratio, saving ratio, set monthly cost, expenditure volatility, and an account balance,
for the syndicated deal offer, calculating, by the social syndicate computing system, a predicted financial health score of the at least some users including the first user based on one or more of a predicted value of a credit score, liquid asset position, liquidity, asset to debt ratio, current ratio, debt service ratio, saving ratio, set monthly cost, expenditure volatility, and an account balance, wherein the respective predicted financial health score is calculated based on the value of the financial factor, and an acceptance by the respective user of the syndicated deal offer, and
identifying, by the social syndicate computing system, the subset of users for which to transmit the syndicated deal offer by comparing, for each of the at least some of the plurality of users, the respective predicted financial health score to a predetermined value according to the one or more parameters received from the business computing device, wherein the subset of users includes the first user and the second user;
transmitting, by the social syndicate computing system via the network to a respective computing device of the subset of users, data corresponding to the syndicated deal offer for display on the respective computing device associated with the subset of users including the first user and the second user;
receiving, by the social syndicate computing system via the network from the respective computing device of the subset of users, acceptances from at least some of the subset of the plurality of users;
adjusting, by the social syndicate computing system, the syndicated deal offer based on the one or more parameters received from the business computing device, wherein the one or more parameters include increasing a discount based on a number of users that accept the syndicated deal offer;
determining, by the social syndicate computing system, the one or more parameters received from the business computing device are met;
generating, by the social indicate computing system, responsive to determining the one or more parameters received from the business computing device are met, a contract for the subset of the plurality of users that accepted the syndicated deal offer to sign; and
transferring, by the social syndicate computing system, responsive to the subset of the plurality of users signing the contract, funds from a temporary account set up by the financial institution computing system to a business account for the business.

2. The method of claim 1, further comprising:
analyzing, by the social syndicate computing system, a social media account of the first user to determine non-financial interests of the first user, and
wherein providing the social syndicate deal platform further includes:
analyzing, by the social syndicate computing system, the financially healthy deal offers based on the non-financial interests of the first user to rank the financially healthy deal offers sent to the first user.

3. The method of claim 1, wherein the plurality of syndicated deal offers include syndicated deal offers that are initiated by an individual user of the social syndicate deal platform.

4. The method of claim 1, wherein the plurality of syndicated deal offers include syndicated deal offers that are initiated by a business user of the social syndicate deal platform.

5. The method of claim 1, further comprising:
receiving, by the social syndicate computing system via the network from the financial institution computing system, financial account information from a financial account for the business;
receiving, by the social syndicate computing system via the network from a computing device of a third user, a user initiated deal offer from the third user; and
wherein providing the social syndicate deal platform further includes:
determining, by the social syndicate computing system, the business provides a good or service rendering it capable of executing the user initiated deal offer;
analyzing, by the social syndicate computing system, the user initiated deal offer to determine if offering the user initiated deal offer would be appropriate for the business, consequent to determining the business provides the good or service; and
sending, by the social syndicate computing system via the network to the business computing device, the user initiated deal offer to the business if the user initiated deal offer would be appropriate for the business for display on the business computing device associated with the business.

6. (canceled)

7. The method of claim 5, wherein analyzing the user initiated deal offer to determine if offering the user initiated deal offer would be appropriate for the first business comprises:
calculating, by the social syndicate computing system, a first financial health score of the business based on one or more of a value of a cash position, solvency ratio, overhead cost, overhead expense percentage, expenditure volatility, profitability ratio, leverage ratio, revenue growth, gross profit margin, and operating margin;
calculating, by the social syndicate computing system, a predicted financial health score of the business based on one or more of a predicted value of a cash position, solvency ratio, overhead cost, overhead expense percentage, expenditure volatility, profitability ratio, leverage ratio, revenue growth, gross profit margin, and operating margin if the business executed the user initiated deal offer; and
determining, by the social syndicate computing system, the predicted financial health score is at least equal to the first financial health score.

8. The method of claim 7, wherein analyzing the user initiated deal offer to determine if offering the user initiated deal offer would be appropriate for the business further comprises determining the predicted financial health score is greater than the first financial health score by a predetermined amount.

9-27. (canceled)

28. A non-transitory computer-readable media having computer-executable instructions embodied therein that, when executed by one or more processors, of one or more computer systems cause the one or more computer systems to perform a process including:
receiving, via a network from a financial institution computing system, financial information from a financial account for a first user;
receiving, via the network from a business computing device associated with a business, one or more parameters relating to a financial health restriction of users restricted from accepting offers of the business;
analyzing the financial information from the financial accounts to determine a respective value of a financial factor of the plurality of users;
providing a social syndicate deal platform, wherein providing the social syndicate deal platform includes:
receiving, via the network by the social syndicate computing system from a device of a second user, a request for a syndicated deal offer requiring at least a subset of the plurality of users including the second user to accept the offer in order for the deal to be executed,
analyzing, for at least some of the plurality of users including the first user, the respective value of the financial factor to identify the subset of users, wherein analyzing the respective value comprises:
calculating the value of the financial factor of the at least some users including the first user based on one or more of a value of a credit score, liquid asset position, liquidity, asset to debt ratio, current ratio, debt service ratio, saving ratio, set monthly cost, expenditure volatility, and an account balance,
for the syndicated deal offer, calculating a predicted financial health score of the at least some users including the first user based on one or more of a predicted value of a credit score, liquid asset position, liquidity, asset to debt ratio, current ratio, debt service ratio, saving ratio, set monthly cost, expenditure volatility, and an account balance, wherein the respective predicted financial health score is calculated based on the value of the financial factor, and an acceptance by the respective user of the syndicated deal offer, and
identifying, by the social syndicate computing system, the subset of users for which to transmit the syndicated deal offer by comparing, for each of the at least some of the plurality of users, the respective predicted financial health score to a predetermined value according to the one or more parameters received from the business computing device, wherein the subset of users includes the first user and the second user;
transmitting, via the network to a respective computing device of the subset of users, data corresponding to the syndicated deal offer for display on the respective computing device associated with the subset of users including the first user and the second user;
receiving, by the social syndicate computing system via the network from the respective computing device of the subset of users, acceptances from at least some of the subset of the plurality of users;
adjusting, by the social syndicate computing system, the syndicated deal offer based on the one or more parameters received from the business computing device, wherein the one or more parameters include increasing a discount based on a number of users that accept the syndicated deal offer;
determining, by the social syndicate computing system, the one or more parameters received from the business computing device are met;
generating, by the social indicate computing system, responsive to determining the one or more parameters received from the business computing device are met, a contract for the subset of the plurality of users that accepted the syndicated deal offer to sign; and
transferring, by the social syndicate computing system, responsive to the subset of the plurality of users signing the contract, funds from a temporary account set up by the financial institution computing system to a business account for the business.

29. The non-transitory computer-readable media of claim 28, wherein the process further includes:
analyzing a social media account of the first user to determine non-financial interests of the first user, and
wherein providing the social syndicate deal platform further includes:
analyzing the financially healthy deal offers based on the non-financial interests of the first user to rank the financially healthy deal offers sent to the first user.

30. The non-transitory computer-readable media of claim 28, wherein the plurality of syndicated deal offers include syndicated deal offers that are initiated by an individual user of the social syndicate deal platform.

31. The non-transitory computer-readable media of claim 28, wherein the plurality of syndicated deal offers include syndicated deal offers that are initiated by a business user of the social syndicate deal platform.

32. The non-transitory computer-readable media of claim 28, wherein the process further includes:
receiving, via the network from the financial institution computing system, financial account information from a financial account for the business;
receiving, via the network from a computing device of a third user, a user initiated deal offer from the third user; and
wherein providing the social syndicate deal platform further includes:
determining the business provides a good or service rendering it capable of executing the user initiated deal offer;
analyzing the user initiated deal offer to determine if offering the user initiated deal offer would be appropriate for the first business, consequent to determining the first business provides the good or service; and
sending, via the network to the business computing device, the user initiated deal offer to the business if the user initiated deal offer would be appropriate for the business for display on the business computing device associated with the business.

33. The non-transitory computer-readable media of claim 32, wherein analyzing the user initiated deal offer to determine if offering the user initiated deal offer would be appropriate for the first business comprises:
calculating a first financial health score of the business based on one or more of a value of a cash position, solvency ratio, overhead cost, overhead expense percentage, expenditure volatility, profitability ratio, leverage ratio, revenue growth, gross profit margin, and operating margin;
calculating a predicted financial health score of the business based on one or more of a predicted value of a cash position, solvency ratio, overhead cost, overhead expense percentage, expenditure volatility, profitability ratio, leverage ratio, revenue growth, gross profit margin, and operating margin if the business executed the user initiated deal offer; and
determining the predicted financial health score is at least equal to the first financial health score.

34. (canceled)

35. The non-transitory computer-readable media of claim 33, wherein analyzing the user initiated deal offer to determine if offering the user initiated deal offer would be appropriate for the business further comprises determining the predicted financial health score is greater than the first financial health score by a predetermined amount.
